(19) United States
(12) Patent Application Publication
(10) Pub. No.: US 2006/0154602 A1
(43) Pub. Date: Jul. 13, 2006

(54) Satellite signal receiving system

(75) Inventor: Il Young Lee, Yongin-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/246,146

(22) Filed: Oct. 11, 2005

(30) Foreign Application Priority Data
Jan. 11, 2005 (KR) 2005-2626

(51) Int. Cl. H04B 7/185

(52) U.S. Cl. 455/13.3

(57) ABSTRACT

A satellite signal reception system accurately receives a specific satellite signal without being affected by other set-top boxes when it is connected to a plurality of set-top boxes. The satellite signal reception system minimizes the distortion of a specific signal by set-top boxes connected to other output ports of a multi-switch without changing a circuit configuration of the multi-switch to another. The satellite signal reception apparatus comprises a multi-switch for switching a plurality of received satellite signals, and transmitting the switched satellite signals to a plurality of receivers; and an adapter which is connected between the multi-switch and a first receiver from among the receivers, and removes noise of a specific satellite signal to be received in the first receiver.

### CROSS-REFERENCE TO RELATED APPLICATION

This application claims the benefit under 35 U.S.C. §119(a) of Korean Patent Application No. 2005-2626, filed on Jan. 11, 2005 in the Korean Intellectual Property Office, the disclosure of which is hereby incorporated by reference.

### BACKGROUND OF THE INVENTION

1. Field of the Invention

The present invention relates to a satellite signal reception system. More particularly, the present invention relates to a satellite signal reception system capable of accurately searching for a desired signal to be received from among a plurality of satellite signals.

2. Description of the Related Art

Recently, digital signal compression technologies, error correction technologies, and semiconductor integration technologies have been rapidly developed, such that the cost of a receiver and the cost of signal transmission have been greatly reduced, and digital broadcast services ranging from a satellite broadcast service to a terrestrial broadcast service can be supplied to most households. Therefore, a digital satellite broadcast service based on a specific frequency band of 12 GHz has been widely applied to a plurality of media services based on digital technologies, for example, a broadcast service, a communication service, and a computer-associated service, among others.

Although several hundred programs have been broadcast to multi-channel digital satellite televisions (TV) of users using a pre-assigned orbit and channel, individual satellite enterprises use different specifications, each of which defines a program ID, a service scheme, and a transmission scheme such as an error correction scheme, such that each user is unable to view all the satellite broadcast programs using only one receiver.

Due to the above-mentioned problem, a large number of users use a plurality of receivers, such as set-top boxes (STBs), and the STBs must selectively receive a desired satellite signal from among a plurality of satellite signals transmitted from a plurality of satellites. For this purpose, there has been recently developed a multi-switch for matching a specific satellite signal from among a plurality of satellite signals to a specific set-top box from among a plurality of set-top boxes.

A variety of satellite signals are applied to an input port of the multi-switch, a set-top box is connected to an output port of the multi-switch. Several set-top boxes can be connected to the output port of the multi-switch. Each set-top box outputs a signal for receiving a desired signal from among a plurality of satellite signals applied to the input port to the output port of the multi-switch. Each satellite signal includes a specific signal level, and the set-top box receives a desired satellite signal using the specific signal level. For example, the satellite signals are set to different voltages, such that a voltage corresponding to a specific satellite signal is detected from among a plurality of satellite signals applied to a plurality of input ports.

In the meantime, as new satellites, other than the conventional satellites already in orbit, are continuously being developed and launched, the number of unique satellite signals that can be assigned that are distinguished from conventional satellite signals is rapidly increasing. Therefore, although a conventional function has distinguished individual satellite signals from each other using different voltages, a new function can distinguish the satellite signals from each other using a specific signal in which a specific frequency is carried at a particular voltage. In other words, although two satellite signals generate the same voltage, one satellite signal is generated in the form of a pulse-shaped signal of a specific frequency, and the other satellite signal is generated in the form of a signal maintaining only the particular voltage, such that the user can distinguish the two satellite signals from each other.

However, in the case where one of a plurality of set-top boxes connected to the multi-switch is configured to receive a satellite signal of 18V, and the other one is configured to receive a pulse signal including a voltage of 18V and a frequency of 22 KHz, a pulse signal generated from each set-top box is affected by interference of other signals as shown in FIG. 1, such that a desired pulse shape is not maintained. As a result, the output terminal of the multi-switch wrongly determines that a satellite signal to be received from the set-top box is the satellite signal of 18V instead of the satellite signal having a voltage of 18V and a frequency of 22 KHz, such that it is unable to receive a desired satellite signal.

### SUMMARY OF THE INVENTION

Therefore, it is an aspect of the invention to provide a satellite signal reception system for accurately receiving a desired satellite signal without being affected by other set-top boxes when it is connected to a plurality of set-top boxes.

It is another aspect of the invention to provide a satellite signal reception system for preventing a desired signal from being distorted by set-top boxes connected to other output ports of a multi-switch without changing a circuit configuration of the multi-switch to another configuration.

Additional aspects and/or advantages of the invention will be set forth in part in the description which follows and, in part, will be obvious from the description, or may be learned by practice of the invention.

In accordance with one aspect of the invention, the above and/or other aspects can be achieved by the provision of a satellite signal reception apparatus, comprising: a multi-switch for switching a plurality of received satellite signals, and transmitting the switched satellite signals to a plurality of receivers; and an adapter which is connected between the multi-switch and a first receiver from among the receivers, and removes noise of a specific satellite signal to be received in the first receiver.

Preferably, the adapter is configured by connecting a resistor to a signal line between the multi-switch and the first receiver.

Preferably, the resistor is set to a predetermined resistance value so that impedance of a port to which the multi-switch and a second receiver are connected cancels a predetermined value applied to the first receiver.

In accordance with another aspect of the present invention, there is provided a satellite signal reception apparatus, comprising a multi-switch for receiving a plurality of satellite signals, and transmitting the received satellite signals to a plurality of receivers; and an adapter for preventing a specific satellite signal detected by a first receiver from among the satellite signals from being affected by the load of the output ports of the multi-switch connected to the receivers such that it can prevent signal interference caused by the load from being generated.

Preferably, the receivers recognize the voltage and frequency information of a satellite signal to be received, search for a satellite signal comprising a corresponding voltage and frequency from among the plurality of satellite signals, and receive the searched satellite signal via the output ports of the multi-switch.

Preferably, if a user configures a first receiver to receive a first satellite signal corresponding to a first voltage and a first frequency via a first output port, and also configures a second receiver to receive a second satellite signal corresponding to the first voltage via a second output port, the impedance of the second output port is determined to be matched with other impedances of an adapter.

Preferably, the adapter is configured by connecting a resistor to a signal line between the multi-switch and the first receiver. The impedance matching reduces the impedance of the signal line such that the impedance of the signal is equal to the impedance of the second output port.

Preferably, if the impedance matching is completed, a signal applied to the first output port is cancelled by the impedance of the second output port after passing through the resistor, and the first satellite signal transmitted from the first receiver is transmitted to the first output port via the signal line.

Preferably, the impedance matching is performed by adjusting a resistance value of the resistor contained in the adapter.

Preferably, the resistor is implemented with a variable resistor.

Preferably, the adapter is connected to a plurality of signal lines among the individual signal lines of the plurality of receivers connected to the multi-switch, or is connected to all the signal lines of the plurality of receivers connected to the multi-switch.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating signal distortion generated by other set-top boxes when receiving a conventional satellite signal;

FIG. 2A is a block diagram illustrating a satellite signal reception system in accordance with an embodiment of the present invention;

FIG. 2B is a block diagram illustrating multi-switch and set-top boxes shown in FIG. 2A in accordance with an embodiment of the present invention;

FIG. 2C shows a line adapter shown in FIG. 2B in accordance with an embodiment of the present invention; and

FIGS. 3A and 3B are graphs illustrating satellite signals detected by the multi-switch shown in FIG. 2B in accordance with an embodiment of the present invention.

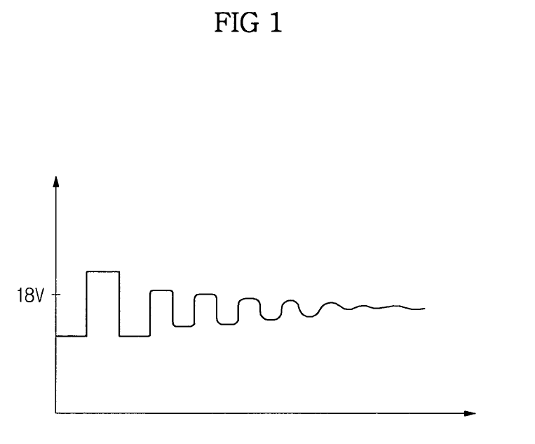

Throughout the drawings, it should be understood that like reference numbers refer to like features, structures and elements

### DETAILED DESCRIPTION OF EXEMPLARY EMBODIMENTS

Reference will now be made in detail to the embodiments of the present invention, examples of which are illustrated in the accompanying drawings, wherein like reference numerals refer to like elements throughout.

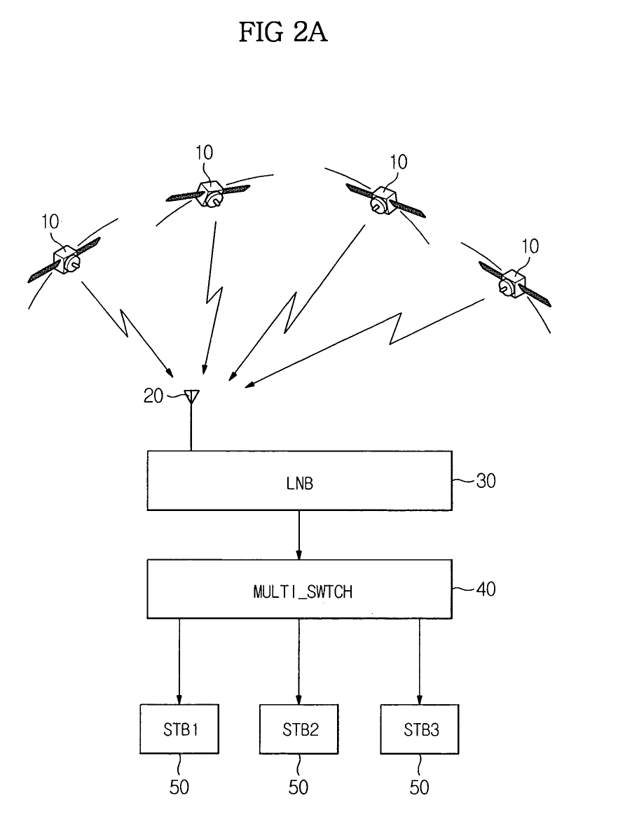

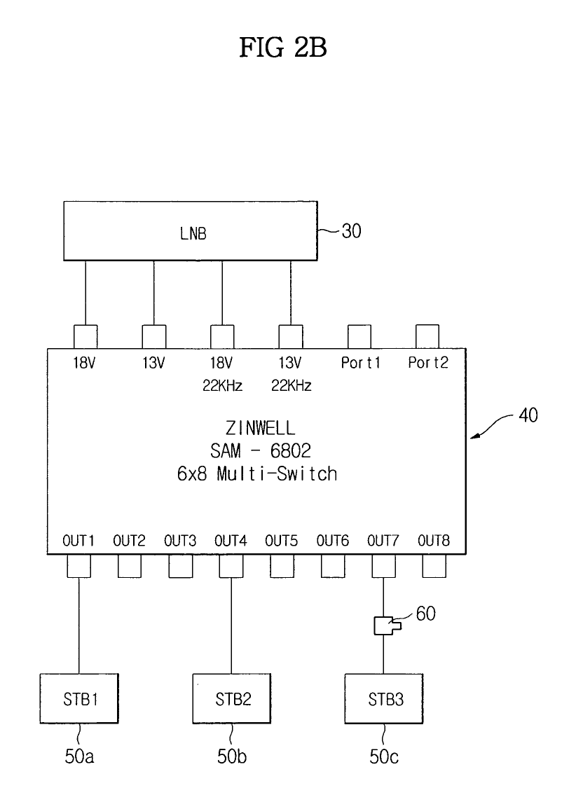

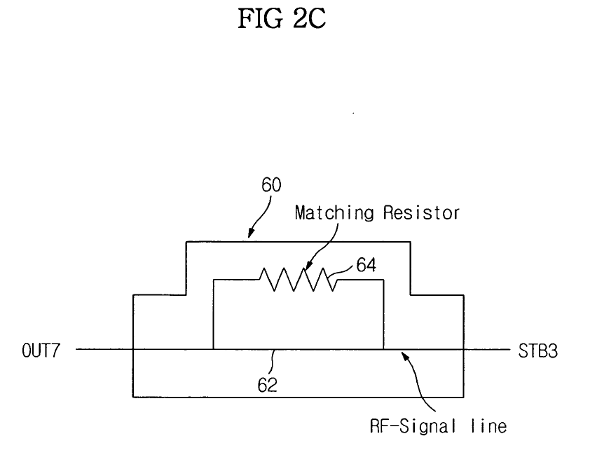

FIG. 2A is a block diagram illustrating a satellite signal reception system in accordance with an embodiment of the present invention. As shown in FIG. 2A, the satellite signal reception system comprises a plurality of satellites 10 which preferably comprises electronic devices, switching devices, and solar panels, and are placed in a variety of orbits at an altitude of about 36000 km; a satellite antenna 20 for receiving signals from the satellites 10; a Low Noise Block (LNB) 30 for converting a signal received from the satellite antenna 20 into another signal so as to reduce noise; a multi-switch 40 for switching to a signal desired by a receiver 50 from among a plurality of satellite signals generated from the LNB 30; and a receiver 50, which is connected to an output port of the multi-switch, that selectively receives a specific signal from among a plurality of satellite signals.

The LNB 30 receives a signal in the SHF band of 3.5 GHz to 12 GHz from the satellite antenna 20, converts the received signal into an Intermediate Frequency (IF) of about 1 GHz, and amplifies the IF signal to acceptable output levels. Also, the LNB 30 removes unnecessary components and noise from a received satellite signal, and transmits the resultant satellite signal to the receiver 50.

The receiver 50 can be implemented with a set-top box (STB) to receive cable or satellite broadcast data. Generally, the set-top box amplifies a video signal received from the satellite antenna 20, removes noise from the received video signal, and transmits a corresponding video signal of a user-desired channel to a TV, such that a user must install a proper set-top box according to a broadcast scheme of the TV, such as analog broadcast scheme or a digital broadcast scheme.

The multi-switch 40 will hereinafter be described with reference to FIG. 2B. As shown in FIG. 2B, the multi-switch preferably comprises 6 input ports and 8 output ports. Individual input ports receive satellite signals via the satellite antenna 20, and each output port is connected to the receiver 50, such that the satellite signals received via the input ports are transmitted to the receiver 50 via the output ports.

Four input ports of 18V, 13V, 18V (22 KHz), and 13V (22 KHz) from among 6 input ports are adapted to interface with an output signal of the satellite antenna 20 receiving satellite signals of 101°, 110°, and 119°. A first port (Port1) and a second port (Port2) receive a satellite signal of 95° W and a satellite signal of 72.5° W, respectively, through the interface with the satellite antenna 20 receiving the satellite signals of 95° W and 72.5° W. The description of the embodiments of the present invention discloses only satellite signals received via the remaining input ports other than the above-mentioned ports (Port1 and Port2). Although, other satellite signals may be received and input ports used.

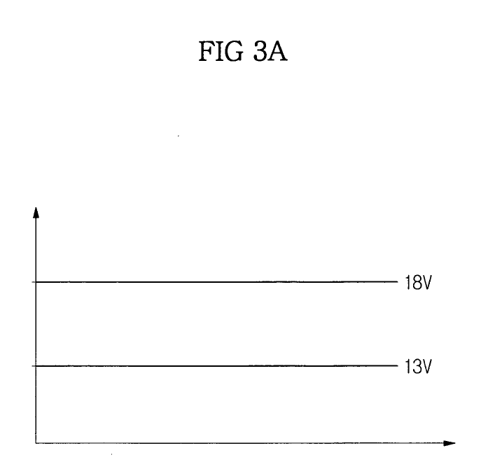

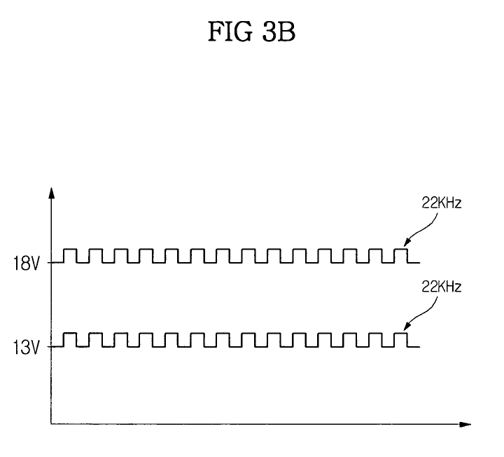

A plurality of satellite signals received via the satellite antenna 20 are applied to the multi-switch 40. Each receiver 50 connected to one of the outputs port selects a specific satellite signal from among a plurality of satellite signals applied to the input ports, and receives the selected satellite signal. For this purpose, the satellite signals applied to individual input ports comprise different signal levels. The receiver 50 searches for a signal level of a specific satellite signal, such that it can receive the specific satellite signal. In more detail, as shown in FIGS. 3A and 3B, the signals applied to the four input ports are a first signal preferably having a voltage level of 18V, a second signal preferably having a voltage level of 13V, a third signal preferably having a pulse signal composed of a voltage of 18V and a frequency of 22 KHz, and a fourth signal preferably having a pulse signal composed of a voltage of 13V and a frequency of 22 KHz.

In the case where a third receiver 50c, which is connected to a seventh output port (OUT7) of the multi-switch 40, is configured to receive the above-mentioned third signal having the pulse signal composed of the voltage of 18V and the frequency of 22 KHz, the third receiver 50c transmits the third signal to the seventh output port (OUT7) as shown in FIG. 3B, such that it searches for an input port generating the same signal as the third signal. If the third receiver 50c finishes searching for the above input port, a satellite signal applied to the input port is received in the third receiver 50c via the seventh output terminal (OUT7).

If the receivers 50a and 50b are connected to other output ports (OUT1 and OUT4) other than the seventh output port (OUT7) and receive satellite signals, the capacitance of the output ports (OUT1 and OUT4) is increased. Therefore, the capacitance of the output ports (OUT1 and OUT4) affects the seventh output port (OUT7), such that the pulse signal of 22 KHz received from the third receiver 50c may not be properly transmitted to the seventh output port (OUT7). In order to prevent the above-mentioned problem from occurring, a line adapter 60 is connected between the seventh output port (OUT7) and the third receiver.

As shown in FIG. 2C, the line adapter 60 is configured by connecting an impedance-matching resistor 64 in parallel to a Radio Frequency (RF) signal transmission line 62 between the output port (OUT7) and the third receiver 50c, such that it can prevent noise and other signal distortions caused by excessive capacitance of the output ports. In more detail, the line adapter 60 matches the impedance of the first output port (OUT1) and the fourth output port (OUT4) to the impedance between the seventh output port (OUT7) and the third receiver 50c, such that it can minimize the signal distortion. If the resistor 64 is connected in parallel to the RF signal transmission line 62, the overall impedance is lowered and close to the impedance of the first output port (OUT1) and the fourth output port (OUT4).

A resistance value of the resistor 64 connected in parallel to the line adapter 60 is determined by the impedance of the output ports of the multi-switch, and may be set to a fixed resistance value. The resistor 64 may be implemented with a variable resistor such that it can actively match the impedance of individual output ports. Also, the line adapter 60 can be connected to only a specific receiver 50c as shown in FIG. 2B, or can also be selectively connected to the signal line 62 requiring impedance matching.

If the above-mentioned impedance matching is performed, the signal distortion caused by capacitance of the first and fourth ports (OUT1 and OUT4) is cancelled by the resistor 64 of the line adapter 64, and the pulse signal of 22 KHz generated from the third receiver 50c is transmitted to the seventh output port (OUT7) via the RF signal transmission line 62, such that satellite signals of the input ports can be accurately detected.

As is apparent from the above description, the satellite signal reception system according to embodiments of the present invention can accurately search for a specific satellite signal without being affected by the output ports connected to the other set-top boxes or receivers even though it simultaneously receives different satellite signals from several set-top boxes using a multi-switch.

Also, the satellite signal reception system can easily perform impedance matching, without changing the circuit configuration of a multi-switch to another configuration to remove noise and other signal distortions caused by excessive capacitance of output ports of the multi-switch.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A satellite signal reception apparatus, comprising:
a multi-switch for switching a plurality of received satellite signals, and transmitting the switched satellite signals to a plurality of receivers; and
an adapter which is connected between the multi-switch and a first receiver from among the receivers, and removes noise of a specific satellite signal to be received in the first receiver.

2. The apparatus according to claim 1, wherein the adapter is configured by connecting a resistor to a signal line between the multi-switch and the first receiver.

3. The apparatus according to claim 2, wherein the resistor is set to a predetermined resistance value so that an impedance of a port to which the multi-switch and a second receiver are connected cancels a predetermined value applied to the first receiver.

4. A satellite signal reception apparatus, comprising:
a multi-switch for receiving a plurality of satellite signals, and transmitting the received satellite signals to a plurality of receivers; and
an adapter for preventing a specific satellite signal detected by a first receiver of a plurality of receivers from among the satellite signals from being affected by load of output ports of the multi-switch connected to the receivers such that it can prevent signal interference caused by the load from being generated.

5. The apparatus according to claim 4, wherein the receivers recognize voltage and frequency information of a satellite signal to be received, search for a satellite signal having a corresponding voltage and frequency from among the plurality of satellite signals, and receive the searched for satellite signal via the output ports of the multi-switch.

6. The apparatus according to claim 5, wherein:
if a user desires to allow the first receiver to receive a first satellite signal corresponding to a first voltage and a first frequency via a first output port, and also desires to allow a second receiver to receive a second satellite signal corresponding to the first voltage via a second output port, the impedance of the second output port is determined to be matched with an other impedance of the adapter.

7. The apparatus according to claim 6, wherein the adapter is configured by connecting a resistor to a signal line between the multi-switch and the first receiver.

8. The apparatus according to claim 7, wherein the impedance matching reduces impedance of the signal line such that the impedance of the signal is equal to the impedance of the second output port.

9. The apparatus according to claim 8, wherein:
if the impedance matching is completed, a signal applied to the first output port is cancelled by the impedance of the second output port after passing through the resistor, and the first satellite signal transmitted from the first receiver is transmitted to the first output port via the signal line.

10. The apparatus according to claim 7, wherein the impedance matching is performed by adjusting a resistance value of the resistor contained in the adapter.

11. The apparatus according to claim 10, wherein the resistor is implemented with a variable resistor.

12. The apparatus according to claim 4, wherein the adapter is connected to a plurality of signal lines among individual signal lines of the plurality of receivers connected to the multi-switch, or is connected to all the signal lines of the plurality of receivers connected to the multi-switch.
